(19) United States
(12) Patent Application Publication
(10) Pub. No.: US 2010/0248185 A1
(43) Pub. Date: Sep. 30, 2010

(54) DENTAL PIN AND USE THEREOF

(76) Inventor: Ricardo Hermelino LEITE, Sao Paulo (BR)

Correspondence Address: OCCHIUTI ROHLICEK & TSAO, LLP, 10 FAWCETT STREET, CAMBRIDGE, MA, 02138, US

(21) Appl. No.: 12/409,542

(22) Filed: Mar. 24, 2009

(51) Int. Cl. A61C 8/00

(52) U.S. Cl. 433/173

(57) ABSTRACT

The present patent is related to a dental pin (1, 1′) and the use thereof, particularly for the recovery of the interdental bone crest, thus allowing the same to be covered so that the wasted gingival papilla can be formed, and restoring the aesthetics of the individual.

### DISCLOSURE OF THE INVENTION

The present patent is directed to a dental pin and the use thereof, particularly for the recovery of interdental bone crest, thus allowing the aesthetic restoration of the individual and the interdental use thereof.

### BACKGROUND OF THE INVENTION

The gingival papilla is the region of the gum located between two neighboring teeth that, when seen in a vestibular or lingual view, shows a pyramidal shape, filling the whole interdental space, that is, from the bone crest to a proximal contact.

It is of great relevance in the protection of both the periodontium of underlying sustentation and the aesthetics of a smile.

The main factors related with its presence are the localization and extension of the proximal contact, coronary contour of adjacent teeth, anatomy of the cement-enamel junction, inter-radicular distance, level of the bone crest and appropriate control of the bacterial plaque by the patient.

The lack thereof compromises the aesthetics of the smile, besides facilitating the gingival retraction, thus leading to the exposition of the root of adjacent teeth, causing pain to the individual.

There are several causes that lead to the loss of the gingival papilla. The gingival retractions may result from iatrogenic factors, traumatic brushing, occlusal factors, or periodontal illness.

The occurrence of this loss when dental elements are pulled out is common, either in view of radicular fracture or periodontal illness, or dental trauma (avulsion) or any another reason.

In adults, the loss of the papilla is frequent when there is a severe agglomeration that may compromise the bone tissue. When they undergo a treatment wherein an incisor is pulled out, aesthetically unsatisfactory results may appear, such as the appearance of voids in the region of the papilla.

Unfortunately, there is a risk of a gingival retraction in the region the tooth is pulled out, mainly if the soft tissue in such an area is thin.

In order to prevent both the unpleasant effect of a retraction and the restoration of the healthful aspect and contour of the gingival papilla, thus restoring its protective and aesthetic function, it is reconstructed in such a way that its contour and normal aspect are recovered.

There have been many proposals for the recovery of the gingival papilla.

In patients whose inter-proximal spaces of the anterior teeth spaces are not filled with gingival papilla, as is normally seen after the surgical extraction of the pocket, there is a common trend to construct wide crowns towards the gingival edge, in order to close the voids. In a disadvantageous way, such measure brings about a gingival irritation related to the underlying inter-proximal edges.

An interdental space that is wider than the regular one is not a periodontal deficiency if the surfaces can be readily accessed for the procedures of oral hygiene. Thus, it is preferred to clean underlying restorations than overlying restorations.

As an alternative to wide crowns, there is a number of surgical techniques for attainment or restoring the gingival papilla such as, for example, the Pallacci technique.

However, none of such techniques reconstructs the interdental bone crest, that serves as a support for the gingival tissue to attain a triangular (pyramidal) shape.

The existing techniques only manipulate soft (gingival) tissues, thus increasing the volume that many times is insufficient.

An older way used for the restoration of the patients was the use of oral implantations used for the purpose of recovering a basic talking and swallowing condition. Basically, it was a functional implantation, without necessarily recovering the aesthetics lost, wherein implantations would be inserted wherever a bone was present, even if the positioning was inadequate and compromised the aesthetics, because there were not many surgical resources to reconstruct the bone, and then receive the implantations. The patients accepted with resignation the results so that they could eat and talk safely again.

However, as years want by, the discovery of new surgical techniques for bone and gingival grafting, the expectation of such patients has grown a lot to the point they have not been satisfied when, for example, the gingival papilla was not recovered and the black holes between dental elements were apparent, also causing the escape of air, compromising the aesthetics and the speech.

In the search for a solution to such inconveniences, techniques for attainment papilla through incisions and movement of gingival tissues had then appeared, with some success and failures too, due to the lack of support of the gingival tissue that was basically dependent on the maintenance of the interdental bone crest, that could not be recovered even by using bone grafting.

Thus, an object of the present invention is a pin to be located in the site where loss of gingival papilla or bone crest has taken place, for recovering the interdental bone crest and allowing the restoration of the aesthetics of the individual.

Schematic figures of a particular embodiment of the invention are shown hereinbelow, whose dimensions and proportions are not necessarily the real ones, since the sole purpose of the figures is to teach several aspects of the invention, the scope of protection of which is determined only by the scope of the attached claims, wherein in said figures:

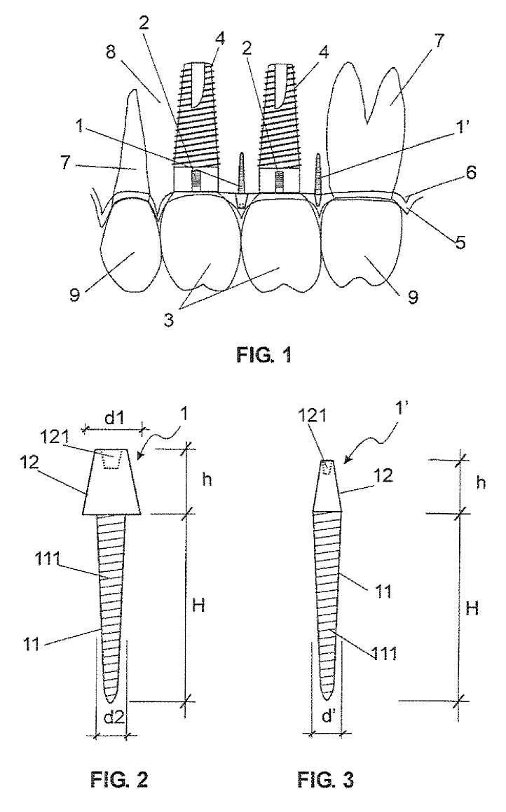

FIG. 1 represents a partial front view of a jaw of a patient with the pin (1, 1′) of the present invention;

FIG. 2 represents an enlarged front view of the pin (1) of the present invention;

FIG. 3 represents a constructive variant (1′) of the pin (1).

### DESCRIPTION OF THE INVENTION

The present invention is directed to a dental pin, particularly for the recovery of interdental bone crest, thus allowing the restoration of the aesthetics of the individual.

As illustrated in FIGS. 1 through 3, the pin (1) is an elongated body provided with two consecutive stretchs (11) e (12). The first stretch or head (12) has a frustoconical shape and is followed by the second stretch or body (11) that is an inverted cone, (d1) being the diameter of the larger base of the first stretch (12), and (d2) being the diameter of base of the second stretch (11). Particularly, and as illustrated in FIG. 2, the larger base of the second stretch (11) is joined to the larger base of the first stretch (12).

FIG. 2 illustrates the pin (1) where the diameter (d1) of the base of the head (12) thereof is bigger than the diameter (d2) of the base of the body (11), thus creating a tooth therebetween. Such tooth, besides being a stopper to the advance of the pin (1) across the bone, allows the reconstitution of a wider base of the papilla in sites where the interdental space is large.

FIG. 3 illustrates a constructive variant of the pin (1), wherein the diameter (d1) of the base of the head (12) thereof is equal to the diameter (d2) of the base of the body (11). Said pin (1′) is designed to be used in sites where the interdental space is narrow, and the widening of the head (12) is not required.

In a second constructive variant of the pin (1), the free end of the head (12) is round, but it may be oval, half-oval, spherical, half-spherical, etc.

Preferably, said first stretch (12) is provided with a central recess (121) on its free end, so that a tool may be lodged therein (not illustrated), for positioning and attaching the pin (1, 1′) to the bone of the individual. The transversal section of the depression (121) is any section designed to lodge the tool, without the occurrence of a false rotation thereof in relation to the pin (1, 1′), what not only allows for the positioning of the pin (1) in the bone but also the rotation thereof with the aid of said tool.

The external part of the second stretch (11) is particularly rough or texturized. More particularly, its roughness is like a projecting helical line (111), such as a kind of thread. Such roughness advantageously improves the interaction between the pin and the bone and generates a mechanism of mechanical anchoring, besides favoring the cellular adhesion during the scarring of the pin (1, 1′).

The first stretch (12) has a length (h) varying from about 2 to 5 mm, preferably 3 mm, that is suitable to replace the bone crest and be recovered by the gum.

Said second stretch (11) has a length (h) varying from about 4 to 6 mm, preferably 5 mm, that advantageously allows the safe attachment to the bone without being too invasive.

The diameter (d1) of the pin (1) ranges between about 1.0 and 1.5 mm, preferably 1.5 mm, and the diameter (d2) ranges between about 1.0 and 1.2 mm, preferably 1.2 mm.

The pin (1′) has a diameter (d′) between about 1.0 and 1.2 mm.

Since the diameters (d1, d2, d′) are reduced, the pins (1 and 1′) are easily recovered by the gum, thus restoring the aesthetics quickly.

The material of each of the stretches (11) and/or (12) is any material suitable to this kind of use, where the stretch (11) can be of plain titanium, titanium with a surface texture, zirconia, alumina; and the stretch (12) can be of plain titanium, painted titanium, zirconia, alumina. The stretches (11) and (12) are made of the same material or of different materials.

FIG. 1 illustrates an example of application of the present pin (1), where two bone integrated implantations (4) can be seen implanted side by side in the bone trabeculation (8), each of which receives a pillar (2) and a prosthetics (3). In said exemplifying figure, a loss of the interdental bone crest can be noticed and also the consequent inversion of gingival papillae in the sites where the pins had been implanted (1, 1′). As illustrated, the gingival papillae (5) are still in their bone crests (6) on the sides of natural teeth (9) and the roots (7) thereof.

As illustrated, the pins (1) and (1′) are accurately located in the center of the remaining bone between implantations and/or adjacent teeth.

For the positioning thereof, a perforation with a specific cylindrical drill is performed in the receiving bed, said drill having a diameter that corresponds to the diameter (d) of the pin (1, 1′). The pin (1, 1′) is then inserted without the need of a screw tap, in such a way that the second stretch or body (11) of the pin (1, 1′) is placed inside the bone and the first stretch or head (22) that is rounded and frustoconical (without sharp edges) is accomodated on the bone surface.

In another aspect, the present invention is related to the use of a dental pin (1, 1′) as an interdental implantation, for the recovery of the gingival papilla of an individual, allowing the restoration of his/her aesthetics.

Said pin (1, 1′) is also used as a support to the gingival tissue in sites where the loss of the gingival papilla has occurred.

With said pin (1, 1′), it is possible to reconstruct the interdental bone crest in order to attain the required support for the gingival tissue to be provided with stability, restoring the natural characteristics and reducing the aspect of long teeth having voids (black holes) between both the implanted teeth and natural teeth.

As it known by one skilled in the art, any other pin with similar functions may be used as a variant of the present invention without departing from the protection delimited by the attached claims.

1. A dental pin comprising an elongated body provided with two consecutive stretches (12) and (11), the first stretch or head (12) having a free end narrower than its base and followed by the second stretch or body (11) that is an inverted cone, (d1) being the diameter of the larger base of the first stretch (12), and (d2) being the diameter of the base of the second stretch (11).

2. The dental pin according to claim 1, wherein the first stretch (12) has a frustoconical shape.

3. The dental pin according to claim 1, wherein the second stretch (11) is externally rough.

4. The dental pin according to claim 3, wherein the roughness of the second stretch (11) is in the shape of a projecting helical line (111).

5. The dental pin according to claim 1, wherein the second stretch (11) has a length (h) that ranges from about 4 to 6 mm.

6. The dental pin according to claim 1, wherein the first stretch (12) has a length (h) that ranges from about 2 to 5 mm.

7. The dental pin according to claim 1, wherein the second stretch (11) is made of any material selected among plain titanium, titanium with a surface texture, zirconia, and alumina.

8. The dental pin according to claim 1, wherein the first stretch (12) is made of any material selected among plain titanium, painted titanium, zirconia, and alumina.

9. The dental pin according to claim 1, wherein the diameter (d1) thereof is about 1.0 to 1.5 mm, and the diameter (d2) is about 1.0 to 1.2 mm.

10. The dental pin according to claim 9, wherein the diameter (d1) is about 1.5 mm.

11. The dental pin according to claim 9, wherein the diameter (d2) is about 1.2 mm.

12. The dental pin according to claim 5, wherein the length (H) of the second stretch (11) is about 5 mm.

13. The dental pin according to claim 6, wherein the length (h) of the first stretch (12) is about 3 mm.

14. The dental pin according to claim 1, wherein the first stretch (11) has a length (h) that ranges from about 4 to 6 mm.

15. The dental pin according to claim 1, wherein the diameter (d1) is the same as (d2) and is from about 1.0 to 1.2 mm.

16. The dental pin according to claim 1, wherein the free end of the first stretch or head (12) is rounded.

17. The dental pin according to claim 16, wherein the shape of the first stretch or head (12) is any shape among half-oval, oval, spherical or half-spherical.

18. The use of the dental pin according to claim 1, characterized by being an interdental implantation with the second stretch or body (11) of the pin (1, 1′) inside the bone and the first stretch or head (12) on the bone surface.

19. The use of the dental pin according to claim 1, characterized by being a support element for a gingival tissue.

20. The use of the dental pin according to claim 1, characterized by being an implantation in the site wherein an interdental bone crest has been lost.

21. The use of the dental pin according to claim 1, characterized by being an element of support for a gingival tissue of the gingival papilla.
